(19) United States
(12) Patent Application Publication
(10) Pub. No.: US 2012/0183716 A1
(43) Pub. Date: Jul. 19, 2012

(54) Moldable ballistic armor panel

(76) Inventors: ROBERT F. JORDAN, BRIER, WA (US); RUSSELL C. WARRICK, SEATTLE, WA (US); CHRIS P. VENTI, REDMOND, WA (US)

(21) Appl. No.: 12/154,434

(22) Filed: May 20, 2008

(51) Int. Cl. F41H 5/04; B32B 38/10; B32B 38/08; B32B 5/26; B32B 37/14

(52) U.S. Cl. 428/47; 428/221; 428/68; 428/76; 428/222; 156/285; 156/267

(57) ABSTRACT

A novel moldable ballistic armor panel having a first outwardly-positioned fracturable layer formed of a ceramic material; a second inwardly-positioned fragment containment layer formed of a consolidated stack of ballistic-resistant laminate sheets, the fragment containment layer being substantially coextensive with the fracturable layer and laminated thereto; and an encapsulation material formed of a resin-impregnated high strength fiber material, the resin-impregnated fiber material at least partially encapsulating the laminated fracturable and fragment containment layers.

### FIELD OF THE INVENTION

The present invention relates generally to an armor product, and in moldable ballistic armor panel formed of a ballistic laminate structure in combination with a fracturable layer for defending against an incoming armor piercing rifle round or fragmentation projectile.

### BACKGROUND OF THE INVENTION

Defense sources, ground and air, are ever seeking lighter, thinner, and more cost effective armor systems. Included in this requirement is a need to have a mass-producible process to accompany the armor product.

However, known armor products and the means for producing the same are limited in their ability to efficiently and reliably provide such a product or means for producing the same.

### SUMMARY OF THE INVENTION

The present invention is a novel moldable ballistic armor panel that overcomes the limitations of the prior art, and an exemplary novel manufacturing method for efficiently and reliably producing the novel moldable ballistic armor panel.

According to one aspect of the novel moldable ballistic armor panel, the novel moldable ballistic armor panel includes: a first outwardly-positioned fracturable layer formed of a ceramic material, and a second inwardly-positioned fragment containment layer formed of a substantially consolidated stack of ballistic-resistant laminate sheets, the fragment containment layer being substantially coextensive with the fracturable layer and coupled thereto; and a resin-impregnated material formed of a high strength fiber material, the resin-impregnated fiber material at least partially encapsulating the laminated fracturable and fragment containment layers. A resin-impregnated fiber material at least substantially covers the fracturable layer, the resin-impregnated fiber material is formed of a high strength fiber material impregnated with a resin.

According to another aspect of the novel moldable ballistic armor panel, the resin-impregnated fiber material further provides an encapsulation layer that at least partially encapsulates the laminated fracturable and fragment containment layers.

According to another aspect of the novel moldable ballistic armor panel, the novel moldable ballistic armor panel further includes a layer of the resin-impregnated fiber material laminated between the fracturable and fragment containment layers.

According to another aspect of the novel moldable ballistic armor panel, when the resin-impregnated fiber material and the thermoplastic film material are dissimilar such that the layers do not adequately mutually adhere, as disclosed herein, the novel moldable ballistic armor panel further includes a substantially continuous interface layer having an undulating intertwined architecture of high performance fiber materials, the interface layer being laminated substantially coextensive between the resin-impregnated fiber material and fragment containment layer. Alternatively, the resin-impregnated fiber material is sewn, stitched, stapled or otherwise mechanically coupled to one or more sheets of a ballistic-resistant laminate material of the fragment containment layer. According to another aspect of the novel moldable ballistic armor panel, the substantially continuous interface layer is instead a substantially continuous adhesive interface layer that is substituted for the interface layer of high performance fibers when the resin portion of the encapsulation material is dissimilar from the polyethylene or other thermoplastic film of the ballistic-resistant laminate structure sheets and is of a type that does not otherwise effectively bond or adhere directly to polyethylene or other thermoplastic film portion of the ballistic-resistant laminate. For example, a substantially continuous coating or film of adhesive is substituted for the substantially continuous interface layer of high performance fibers for adhesively bonding the dissimilar encapsulation material to the polyethylene or other thermoplastic film of the ballistic-resistant laminate structure sheets.

According to another aspect of the novel moldable ballistic armor panel, the fracturable layer further includes a single substantially continuous unitary sheet of the ceramic material having an impact surface facing away from the fragment containment layer, and an array of fracture arresters formed at least across the impact surface thereof.

According to another aspect of the novel moldable ballistic armor panel, the fracturable layer instead further includes a plurality of closely spaced individual unitary tiles of the ceramic material arrayed along a common surface.

According to another aspect of the novel moldable ballistic armor panel, the novel moldable ballistic armor panel having the fracturable layer formed of a plurality of closely spaced individual unitary tiles of the ceramic material further includes a substantially rigid support layer laminated between the fracturable layer and the fragment containment layer.

According to another aspect of the novel moldable ballistic armor panel, the novel moldable ballistic armor panel having the fracturable layer formed of a plurality of closely spaced individual unitary tiles of the ceramic material and the substantially rigid support layer further includes a layer of the resin-impregnated fiber material laminated between the support layer and the fragment containment layer.

According to another aspect of the novel moldable ballistic armor panel, in the novel moldable ballistic armor panel having the fracturable layer formed of a plurality of closely spaced individual unitary tiles of the ceramic material, the common surface having the ceramic material arrayed there along, is further formed with an at least partially contoured surface.

According to another aspect of the novel moldable ballistic armor panel, wherein the one or more ballistic-resistant laminate sheets further is formed of a plurality of positionally stabilized unidirectional high performance fiber materials, and having no more than about 25% by weight of thermoplastic material, no more than about 5% by weight of adhesive adhering the sheets of thermoplastic material to the high performance fiber materials, and a balance of the high performance fiber materials.

According to another aspect of the novel moldable ballistic armor panel, a novel method is provided for molding a ballistic armor panel, the method including: stacking together a plurality of ballistic-resistant laminate sheets in a fragment containment layer having a common outer surface, each of the ballistic-resistant laminate sheets having a plurality of positionally stabilized unidirectional high performance fiber materials; positioning a fracturable layer formed of a ceramic material in a position that is substantially coextensive with the common outer surface of the fragment containment layer; positioning a resin-impregnated fiber material formed of a high strength fiber material over at least the fracturable layer; at least sealing, and optionally entirely enclosing, the fragment containment layer, the fracturable layer and the resin-impregnated fiber material in a sealable enclosure; with the fragment containment layer, the fracturable layer and the resin-impregnated fiber material enclosed in the sealable enclosure, drawing a vacuum on the sealable enclosure; compressing the ceramic material of the fracturable layer relative to the ballistic-resistant laminate sheets of the fragment containment layer; and while being enclosed in the sealable enclosure and the vacuum being drawn thereon, heating the fragment containment layer, the fracturable layer and the resin-impregnated fiber material.

According to another aspect of the novel method for molding a ballistic armor panel, the act of sealing or entirely enclosing the fragment containment layer, the fracturable layer and the resin-impregnated fiber material in a sealable enclosure is further defined by entirely enclosing the fragment containment layer, the fracturable layer and the resin-impregnated fiber material in a collapsible vacuum bag. Additionally, drawing a vacuum on the collapsible vacuum bag in ambient atmospheric conditions further operates for generating a differential pressure between an interior of the collapsible vacuum bag and ambient atmosphere which results in compressing the ceramic material of the fracturable layer relative to the ballistic-resistant laminate sheets of the fragment containment layer. Therefore, according to another aspect of the novel method for molding a ballistic armor panel, drawing a vacuum on the sealable enclosure further includes the act of compressing the ceramic material of the fracturable layer relative to the ballistic-resistant laminate sheets of the fragment containment layer.

According to another aspect of the novel method for molding a ballistic armor panel, the act of positioning a fracturable layer having a ceramic material in a position that is substantially coextensive with the common outer surface of the fragment containment layer further includes closely spacing a plurality of individual unitary tiles of the ceramic material in an array that is positioned substantially coextensive with the common outer surface of the fragment containment layer.

According to another aspect of the novel method for molding a ballistic armor panel, the method further includes positioning a substantially rigid support layer between the fragment containment layer and the fracturable layer in a position that is substantially coextensive with both the fragment containment layer and the fracturable layer.

According to another aspect of the novel method for molding a ballistic armor panel, the method further includes positioning a resin-impregnated fiber material formed of a resin and an undulating intertwined architecture of high strength fiber material between the fragment containment layer and the fracturable layer in a position that is at least substantially coextensive with both the fragment containment layer and the fracturable layer.

According to another aspect of the novel method for molding a ballistic armor panel, the act of positioning a resin-impregnated fiber material between the fragment containment layer and the fracturable layer further includes: selecting the resin-impregnated fiber material to be of a type that is dissimilar from a thermoplastic film portion of the ballistic-resistant laminate sheets of the fragment containment layer; and positioning a substantially continuous interface layer of high performance fiber materials between the dissimilar resin-impregnated fiber material and the fragment containment layer.

According to another aspect of the novel method for molding a ballistic armor panel, the act of positioning a resin-impregnated fiber material comprising a high strength fiber material over the fracturable layer and fragment containment layer further includes: selecting the resin-impregnated fiber material to further include a resin having one of a melting point temperature and curing point temperature that is commensurate with a melting point temperature of a thermoplastic film portion of the ballistic-resistant laminate sheets.

According to an alternative aspect of the novel method for molding a ballistic armor panel that includes positioning a resin-impregnated fiber material of a high strength fiber material over the fracturable layer and fragment containment layer, the resin-impregnated fiber material of a high strength fiber material between the fragment containment layer and the fracturable layer is optionally selected from a group of resin-impregnated fiber materials that are dissimilar from a thermoplastic film portion of the ballistic-resistant laminate sheets such that the layers do not adequately adhere to one another, as disclosed herein. When the resin-impregnated fiber material between the fragment containment layer and the fracturable layer is dissimilar from the thermoplastic film portion of the ballistic-resistant laminate sheets in a way that limits mutual adhesion, as disclosed herein, the novel method for molding the ballistic armor panel also includes optionally positioning a substantially continuous interface layer between the resin-impregnated fiber material and the fragment containment layer. The interface layer is, for example, either a substantially continuous layer of woven, knitted, braided or other undulating intertwined architecture of high performance fiber materials. Else, the interface layer is a substantially continuous coating or film of adhesive that is substituted for the undulating intertwined architecture of high performance fiber materials.

According to another aspect of the novel method for molding a ballistic armor panel, the method further includes at least partially encapsulating the laminated fracturable and fragment containment layers with the resin-impregnated fiber material.

According to another aspect of the novel method for molding a ballistic armor panel wherein the method further includes at least partially encapsulating the laminated fracturable and fragment containment layers with the resin-impregnated fiber material, the method yet further includes subsequently trimming at least a portion of the resin-impregnated fiber material from one or more edge portions of the fragment containment layer.

According to another aspect of the novel method for molding a ballistic armor panel, the act of positioning a resin-impregnated fiber material formed of a high strength fiber material over the fracturable layer and fragment containment layer further includes: selecting the resin-impregnated fiber material to be of type having a resin that is dissimilar from a thermoplastic film portion of the ballistic-resistant laminate sheets, and having one of either a melting point temperature or a curing point temperature that is different from a melting point temperature of a thermoplastic film portion of the ballistic-resistant laminate sheets; and at least partially encapsulating both the laminated fracturable and fragment containment layers with the resin-impregnated fiber material. The act of heating the fragment containment layer, the fracturable layer and the resin-impregnated fiber material is further defined by: heating the fragment containment layer, the fracturable layer and the resin-impregnated fiber material to at least the melting point temperature of the thermoplastic film portion of the ballistic-resistant laminate sheets, and either initially or subsequently to heating the fragment containment layer, the fracturable layer and the resin-impregnated fiber material to at least the melting point temperature of the thermoplastic film portion of the ballistic-resistant laminate sheets, also heating the fragment containment layer, the fracturable layer and the resin-impregnated fiber material to at least the melting point temperature or curing point temperature of the dissimilar resin.

According to another aspect of the novel method for molding a ballistic armor panel wherein the resin-impregnated fiber material is further selected to be of type having a resin that is dissimilar from a thermoplastic film portion of the ballistic-resistant laminate sheets, and having one of either a melting point temperature or a curing point temperature that is different from a melting point temperature of a thermoplastic film portion of the ballistic-resistant laminate sheets, the act of heating the fragment containment layer, the fracturable layer and the resin-impregnated fiber material is further defined as being a solitary two-stage thermal cycle, with the solitary two-stage thermal cycle including both: the act of heating the fragment containment layer, the fracturable layer and the resin-impregnated fiber material to at least the melting point of the thermoplastic film portion of the ballistic-resistant laminate sheets, and the act of heating the fragment containment layer, the fracturable layer and the resin-impregnated fiber material to at least the different melting temperature or curing temperature of the dissimilar resin.

According to another aspect of the novel method for molding a ballistic armor panel, the act of stacking together a plurality of ballistic-resistant laminate sheets in a fragment containment layer having a common outer surface, with each of the ballistic-resistant laminate sheets formed of a plurality of positionally stabilized unidirectional high performance fiber materials is further defined by stacking together a plurality of ballistic-resistant laminate sheets each having no more than about 25% by weight of thermoplastic material, no more than about 5% by weight of adhesive adhering the sheets of thermoplastic material to the high performance fiber materials, and a balance of the high performance fiber materials.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a side view into one exemplary embodiment of a novel moldable ballistic armor panel;

FIG. 2 is a side view into one alternative embodiment of the novel moldable ballistic armor panel;

FIG. 3 is a top or plan view of one configuration of the novel moldable ballistic armor panel;

FIG. 4 is a top or plan view of another configuration of the novel moldable ballistic armor panel;

FIG. 5 illustrates an exemplary manufacturing method for efficiently and reliably producing the novel moldable ballistic armor panel;

FIGS. 6 and 7 illustrate other embodiments of the novel moldable ballistic armor panel each having a substantially rigid support backing between an array of ceramic tiles and a stack of ballistic laminate sheets;

FIG. 8 illustrates a substantially continuous interface layer of woven, knitted, braided or other undulating intertwined architecture of high performance fibers optionally inserted between the top sheet of ballistic laminate and a resin-impregnated high strength fiber material at least partially encapsulating the novel moldable ballistic armor panel;

FIG. 9 illustrates the substantially continuous interface layer of high performance fibers;

FIG. 10 illustrates a substantially continuous adhesive interface layer substituted for the interface layer of high performance fibers illustrated in FIG. 8;

FIG. 11 illustrates the encapsulation layer as being optionally formed with precision dimensions;

FIG. 12 illustrates another embodiment of the novel moldable ballistic armor panel wherein the encapsulation layer is formed substantially completely around the fracturable layer, and wherein the encapsulation is optionally eliminated from covering the fragment containment layer, except at an interface therebetween;

FIG. 13 is a three-dimensional exploded view of alternative installations of arrays of the novel moldable ballistic armor panel on a tank body;

FIGS. 14, 15 and 16 illustrate another application of the novel moldable ballistic armor panel, wherein a plurality of the moldable ballistic armor panels is installed on a vehicle seat;

FIG. 17 shows a perspective view of an exemplary contoured molded armor shell of the novel moldable ballistic armor panel for a vehicle seat;

FIG. 18 is a cross section view that illustrates the novel moldable ballistic armor panel forming the contoured ballistic armor shell for a vehicle seat, as illustrated in FIG. 17;

FIG. 19 is an isometric diagram that illustrates another embodiment of the molded armor shell for a vehicle seat, wherein the molded armor shell is an assembly of the smaller partial shell panels or members;

FIGS. 20 and 21 illustrate an articulated armor vest formed of the novel moldable ballistic armor panel;

FIG. 22 illustrates in some detail a representative construction of either or both of the front armor panel and rear armor panel of the armor vest formed of the novel moldable ballistic armor panel, as illustrated in FIGS. 20 and 21;

FIG. 23 illustrates an example of another armor vest formed of the novel moldable ballistic armor panel; and

FIG. 24 illustrates yet another example of an armor vest formed of the novel moldable ballistic armor panel.

### DETAILED DESCRIPTION OF PREFERRED EMBODIMENT

In the Figures, like numerals indicate like elements.

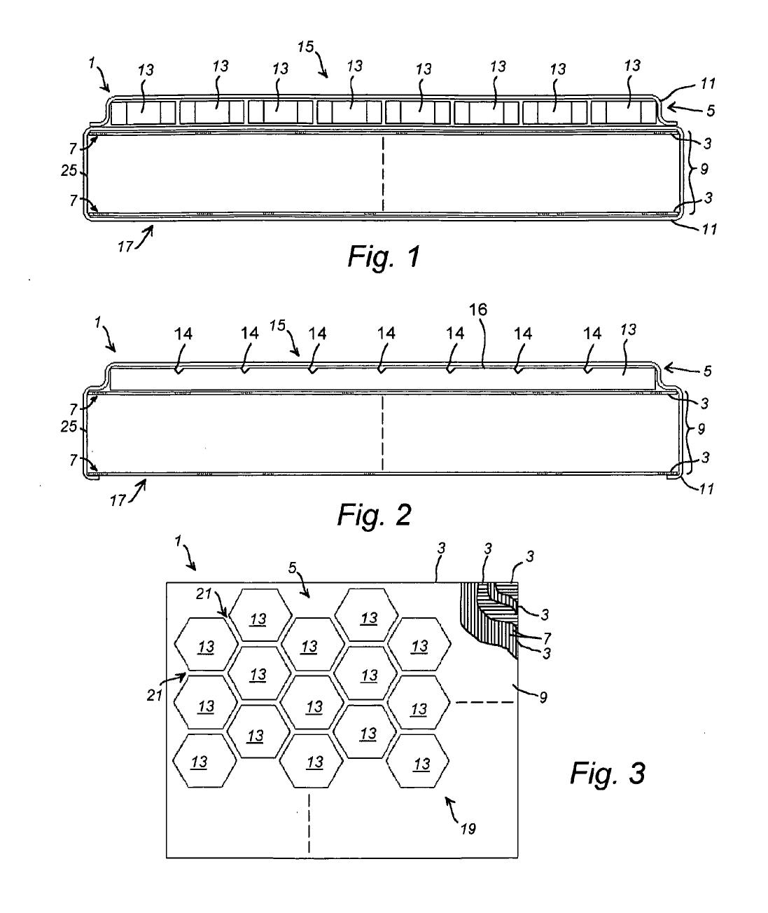

FIG. 1 is a side view into a novel moldable ballistic armor panel 1 formed of multiple ballistic-resistant laminate structures 3 in combination with a fracturable layer 5 for defending against an incoming armor piercing rifle round or fragmentation projectile. As is well-known in the art, each ballistic-resistant laminate structure 3 is formed of a plurality of positionally stabilized unidirectional high performance fiber materials 7 composed, for example, of either unidirectional polyethylene fibers or unidirectional aramid fibers in a substantially continuous woven, knitted, braided or other undulating intertwined architecture. For example, the plurality of positionally stabilized unidirectional high performance fiber materials 7 include, but are not limited to, poly(-phenylenediamine terephthalamide) fibers produced commercially by DuPont Corporation of Wilmington, Del. under such trade names as Kevlar® 29, Kevlar® 49 and Kevlar® 129, but not limited thereto. Alternatively, the plurality of positionally stabilized unidirectional high performance fiber materials 7 of the ballistic-resistant laminate structure 3 are composed, for example, of high performance fiber materials as disclosed in the prior art by U.S. Pat. Nos. 4,916,000; 4,079,161; 4,309,487 and 4,213,812, which are all incorporated in entirety herein by reference. A non-woven ballistic-resistant laminate referred to by the trademark “Spectra-Shield” is manufactured by Honeywell, Inc. The laminate structure is used in soft body armor to protect the wearer against high-velocity bullets and fragments. “Spectra-Shield” was made by first forming a non-woven unidirectional tape, which was composed of unidirectional polyethylene fibers and an elastic resin material that held the fibers together. The resin penetrated the fibers, effectively impregnating the entire structure with the resin product. Two layers, or arrays, of the unidirectional tape were then laminated together (cross-plied) at right angles to form a panel. The panel was then covered on both sides with a film of polyethylene. The film prevented adjacent panels from sticking together when the panels were layered in the soft body armor. The final panel was heavier and stiffer than desired for use as a ballistic-resistant panel. The weight and stiffness were due in part to the penetration of the entire structure with the resin product.

By example and without limitation, each ballistic-resistant laminate structure 3 is formed of a plurality of positionally stabilized unidirectional high performance fibers are arranged in a substantially parallel or overlapping manner between two sheets of 0.00027 to about 0.00035 inch thick polyethylene thermoplastic and held in place with a pressure sensitive adhesive (PSA) applied at about 0.00025 inch or less thick. Such thin sheets of polyethylene additionally cause the ballistic-resistant laminate structures 3 to be more flexible whereby they are more easily contoured to a nonplanar surface. Furthermore, in contrast to the thicker polyethylene film of the prior art that stuck to one another, the thin sheets of polyethylene slide easily relative to one another which facilitates stacking and other arranging of the ballistic-resistant laminate structures 3 during manufacturing of the moldable ballistic armor panel 1. Composite ballistic-resistant structures of a type useful as the ballistic-resistant laminate structure 3 are disclosed, by example and without limitation, in U.S. Pat. Nos. 6,846,548 and 7,211,291, which are all incorporated in its entirety herein by reference, having a plurality of filaments arranged in a fibrous web that is held together in a unitary structure by a domain matrix. The domain matrix is formed of a plurality of separated matrix islands that individually connect, or bond, at least two filaments, to thereby hold the filaments in a unitary structure. Portions of the filament lengths within the unitary structure are free of matrix islands, causing the domain matrix to be discontinuous. The composite may be formed into cross-plied structures.

Non-woven ballistic-resistant laminates without resins of a type useful as the ballistic-resistant laminate structure 3 are disclosed, e.g., in U.S. Pat. Nos. 5,437,905; 5,443,882; 5,443,883 and 5,547,536, which are all incorporated in its entirety herein by reference. A sheet of non-woven ballistic-resistant laminate structure was constructed of high performance fibers without using resins to hold the fibers together. Instead of resin, thermoplastic film was bonded to outer surfaces of two cross-plied layers of unidirectional fibers to hold the fibers in place. The film did not penetrate into the fibers. A sufficient amount of film resided between the bonded layers to adhere the layers together to form a sheet. Bonding the two layers of unidirectional fibers cross-plied to one another was necessary to meet structural requirements of the ballistic-resistant panel, such as impact force distribution. The individual sheets were placed loosely in a fabric envelope of an armored garment to form a ballistic-resistant panel.

Another sheet of unidirectionally-oriented fiber strands includes unidirectional fibers, bonding fibers interwoven with the unidirectional fibers to form a fiber panel, and thermoplastic film laminating the fiber panel there between that may be useful for ballistic-resistant laminate structure 3 is disclosed, by example and without limitation, in U.S. Pat. No. 6,562,435, which is incorporated in its entirety herein by reference. In one embodiment disclosed in U.S. Pat. No. 6,562,435, a second sheet of laminated unidirectional fibers is joined to the first sheet of laminated unidirectional fibers with the unidirectional fibers running in a second direction as compared to the first fibers. In yet another embodiment, individual laminated sheets of unidirectional fibers are stitched together to form packets of sheets which may be used singularly or multiple packets may be bundled together.

A fragment containment layer 9 is formed by a stack of ballistic-resistant laminate structure sheets 3, in the exemplary range of 3 sheets up to 650 sheets, the sheets 3 are arranged in alternating 90° angles and are heat molded. Conventional teaching is to use up to 30% or 35% by weight of PSA and polyethylene because it has been believed to generate better ballistic performance. However, one configuration of the ballistic-resistant laminate structure sheets 3 as determined through our own testing and research is to have less than about 5% by weight of PSA and about 20% to 25% or less by weight of polyethylene (or another thermoplastic material) with the balance being made up of the ballistic fiber material 7. This configuration of less than about 20% to 25% by total weight of thermoplastic material has also been determined through our own testing and research to prevent the melt from entering the vacuum tubing, reduce costs, and generate a cleaner final product.

A resin-impregnated fiber material 11 is used to at least partially or optionally substantially completely (shown) encapsulate the processed ballistic-resistant laminate sheets 3 in the laminate stack 9. The resin-impregnated encapsulation material 11 is a sheet of high strength fiber material, such as but not limited to a fiberglass, aramid or carbon or other fiber material that is impregnated or infused with a thermoplastic or thermosetting polymer resin. The high strength fiber sheet of the encapsulation material 11 is either initially “pre-impregnated” with the resin, or the fiber sheet is infused during forming of the novel moldable ballistic armor panel 1. The resin portion of the encapsulation material 11 is selected to have nearly the same melting or curing temperature as the melting point of the polyethylene or other thermoplastic film of the ballistic-resistant laminate sheets 3. Such selection of the resin portion of the encapsulation material 11 permits thermal cycling with the thermoplastic film so that the resin is melted or cured in the same operation and at the same time as melting of the thermoplastic film of the ballistic-resistant laminate sheets 3 in the laminate stack 9, which reduces process time. When the fiber sheet of the encapsulation material 11 is not pre-impregnated with the resin, the resin is added as a gel or sheet to the fiber sheet during processing, and the resin is infused into the fiber sheet during thermal cycling of the thermoplastic film.

Alternatively, the resin portion of the encapsulation material 11 is optionally selected to have a different melting or curing temperature as may be desirable to achieve a particular performance parameter, and is processed either before or after the thermoplastic film in a single two-stage thermal cycle.

In order to provide the fracturable layer 5, at least one ceramic sheet or tile 13 is introduced onto the first layer of resin-impregnated fiber encapsulation material 11, which is laid over the stack 9 of processed ballistic-resistant laminate sheets 3. Then, more resin-impregnated fiber material 11 is arranged to encapsulate the ceramic tile 13 of the fracturable layer 5. The panel 1 is then heated in an oven, under vacuum, which draws out air between adjacent ballistic-resistant laminate sheets 3, which permits the oven to melt and fuse adjacent sheets 3. The vacuum thus both compacts the stack 9 of ballistic-resistant laminate sheets 3 under compressive force of differential pressure between the vacuum 29 and ambient atmospheric pressure, and also permits adjacent sheets 3 to fuse together upon melting, while heating the panel 1 in an oven simultaneously melts or cures the resin-impregnated fiber encapsulation material 11. As determined through our own testing and research, the resultant panel 1 is firmly consolidated with no excess thermoplastic, no out-gassing, no bubbling, and no voids.

Alternatively, as illustrated in the side view of FIG. 2, the fracturable layer 5 is provided by at least one ceramic sheet or tile 13 which is introduced directly onto the fragment containment layer 9 of stacked ballistic-resistant laminate structure sheets 3. For example, as illustrated here, the fracturable layer 5 is provided by a single large continuous and unitary ceramic sheet 13. Then, the resin-impregnated fiber material 11 is used to substantially encapsulate the ceramic tile 13 along with the stack 9 of ballistic-resistant laminate sheets 3. Optionally, the resin-impregnated fiber encapsulation material 11 does not extend over a backside portion 17 of the panel 1 opposite from the ceramic 13. Else, the resin-impregnated fiber encapsulation material 11 does extend over the panel backside portion 17, as illustrated in FIG. 1.

Either alternative configuration results in a panel 1 of a thickness that can be selected as a function of the threat being defended. Inclusion of the fracturable layer 5 in the form of the ceramic tile 13 is optional as a function of the threat being defended.

Thus, the panels 1 can be made in multiple configurations, with the thickness of the stack 9 of ballistic-resistant laminate structure sheets 3, i.e., the number of sheets 3, and both the material and thickness of the ceramic tile 13 being selected as a function of the threat being defended.

The panels 1 lend themselves to mass production. The production process includes only one single thermal cycle without any secondary bonding process being required. The ballistic-resistant laminate structure sheet components 3 are made at one time, simultaneously. According to one embodiment, a layer of the resin-impregnated fiber encapsulation material 11 is laid on the stack 9 of ballistic-resistant laminate sheets 3, the ceramic 13 of the fracturable layer 5 is laid on that, and then another layer of resin-impregnated fiber encapsulation material 11 is laid on the ceramic 13.

The thickness of the panel 1, including both the ballistic-resistant laminate sheets 3 in the fragment containment layer 9, and the ceramic 13 of the fracturable layer 5, is optimized for armor piercing 0.30-06 rounds is determined at 3000 fps, as is the optimized thickness for fragmentation projectiles per Mil-Std-2103B at 6000 fps.

The fully molded panel 1, with a minimum of thermoplastic, and processed under vacuum, is thin and simultaneously provides all of the ballistic performance for which aramid and other high strength fibers were invented and does so in a very volumetrically compact package. Adding an outwardly-positioned fracturable layer 5 in the form of ceramic armor 13 to a front strike face 15 disables the penetrating feature of armor piercing projectiles, so that the relatively thin consolidated stack 9 of ballistic-resistant laminate sheets 3 is sufficient for stopping the resulting fragments from exiting the opposite backside 17 of the molded panel 1. The ceramic armor 13 of the outwardly-positioned fracturable layer 5 is provided in the form of either a continuous sheet or individual tiles.

Accordingly, the first fracturable layer 5 is arranged to receive the impact from an armor piercing projectile prior to the second fragment containment layer 9 and engages the projectile to fracture the projectile and slow its velocity. The first fracturable layer 5 fractures upon receiving the impact from an armor piercing projectile and dissipates the incoming kinetic energy of the impact. The second fragment containment layer 9 is substantially coextensive with the first fracturable layer 5 and dissipates the remaining energy of the impact to resist complete penetration of the second layer by the projectile. The second fragment containment layer 9 also engages and contains fragments of the ceramic tile 13 fractured by the impact.

The molded panels 1 are thin yet effective, stopping any standard ball round (II, IIIa) according to the NIJ standard, where NIJ is the National Institute of Justice, a government agency, non-military, that establishes criteria for ballistic testing. The ceramic 13 is itself thin, e.g., 6 mm to 8 mm but optionally thicker as a function of the threat to be defended, used with the consolidated stack 9 of ballistic-resistant laminate sheets 3 defeats NIJ-standard III and IV. The high-speed, high kinetic energy fragmentation projectile is also defeated by the consolidated stack 9 of ballistic-resistant laminate sheets 3 with the thin ceramic 13, all encapsulated in resin-impregnated fiber material 11.

The encapsulation material 11 can be painted; it can be drilled to attach fasteners, and facilitates using the panels 1 in a number of applications. This feature makes the panels 1 versatile and useable in a myriad of applications.

The ceramic 13 of the fracturable layer 5 absorbs and dissipates a great deal of kinetic energy and also serves to fracture the incoming armor piercing rifle round or fragmentation projectile. In doing so, the ceramic 13 typically fractures and is rendered useless to prevent a second hit in the same zone, unless specially constrained to resist shattering, as is well known in the art. However, ceramics that are specially constrained to resist shattering are achieved only by expensive secondary processing that adds both cost and physical weight to the ceramic sheet 13. Thus, when the fracturable layer 5 is provided by one large, continuous unitary ceramic sheet 13 that is not specially constrained to resist shattering, the sheet 13 is optionally formed with fracture arresters 14 at intervals to prevent the propagation of cracks from one segment to a neighboring segment. By example and without limitation, a grid of the fracture arresters 14 is provided as shallow cuts that score the ceramic sheet 13 at intervals across an outer or impact surface 16 thereof facing away from the fragment containment layer 9. The shallow cuts that form the fracture arresters 14 are optionally cut by laser or water jet cutting tools, else by another known tool for cutting ceramic.

It is also known to provide the fracture arresters 14 in a one piece ceramic armor plate by cutting a rectangular grid of short grooves through the ceramic plate, whereby a plurality of connected segments are created that are functionally separated by fracture arresters that prevent the propagation of cracks from one segment to a neighboring segment. See, e.g., U.S. patent application Ser. No. 11/561,144, filed in the names of Bernhard Heidenreich and Martin Nedele on Nov. 17, 2006, the complete disclosure of which is incorporated by reference herein.

Accordingly, other methods are known for providing the fracture arresters 14 in a one piece ceramic armor plate 13, and such other methods are also contemplated and may be substituted without deviating from the scope and intent of the present invention.

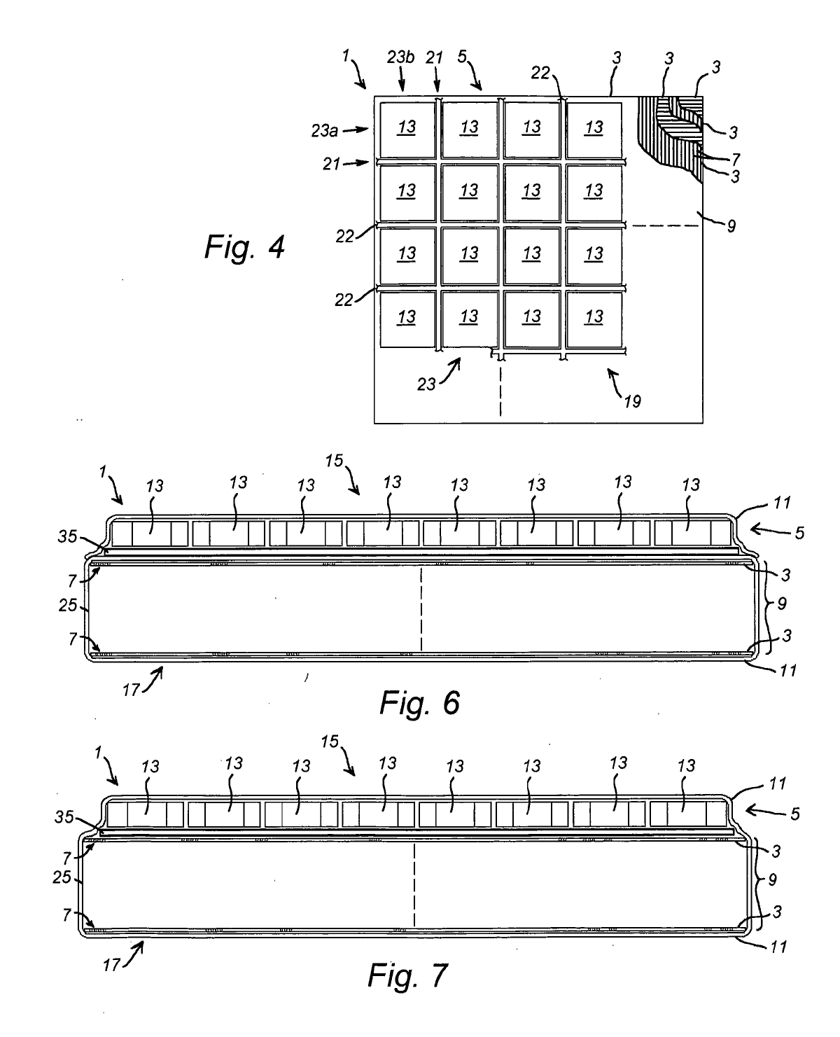

Although the ceramic 13 is optionally a large sheet, according to one embodiment illustrated by example and without limitation in FIG. 3, the fracturable layer 5 is alternatively provided as a plurality of small rectangular, square or hexagonal (shown) ceramic tiles 13 that are arranged side by each in a pattern 19, such as a honeycomb when the tiles 13 are hexagonal. The pattern 19 includes only the barest of distance 21 between any two tiles 13. The slight distance 21 between adjacent tiles 13 provides a fracture arrest or stop such that, if one tile 13 is fractured, only that tile 13 fractures, and the balance of tiles 13 in the panel 1 remains intact and able to protect against another armor piercing round. Optionally, as illustrated in FIG. 4, a buffer material 22, such as an elastomer or aramid fiber, may be inserted in the spaces 21 between adjacent tiles 13 to absorb impacts from shards of adjacent tiles 13 during fracture of the fracturable layer 5. Only an unlikely direct hit in the same spot will defeat the ballistic panel 1. Typically in the event of attack the firefight is quick and the response immediate and the likelihood of continued attack, especially in the same location on the panel 1, is remote. This is the tradeoff for cost and lightweightness.

FIG. 4 illustrates the ceramic tiles 13 of the fracturable layer 5 being small, substantially square or rectangular shaped and arranged side by each in a substantially square or rectangular pattern 19 with only the barest of distance 21 between any two tiles 13. FIG. 4 also illustrates the buffer material 22, which is optionally inserted in the spaces 21 between adjacent tiles 13. Although illustrated for the configuration of FIG. 4, the buffer material 22 is equally applicable to all configurations of the panel 1 including the hexagonal configuration illustrate in FIG. 3.

The ceramic tiles 13 illustrated in either FIG. 3 or FIG. 4 are optionally initially interconnected in a prior processes into larger arrays 23 consisting, for example, of 3-by-3 or 4-by-4 rows 23a and columns 23b of smaller tiles 13, as illustrated. For example, the individual tiles 13 are positioned in a mold die with the spacings 21 between adjacent tiles 13. A connecting material (indicated at 22) is introduced into the spacings 21, for example, by an injection or compression molding process. The connecting material 22 is, by example and without limitation, any of a moldable plastic, polyurethane foam, or fiberglass or epoxy resin, or another suitable connecting material that is compatible with the material of the tiles 13 and suited to the selected molding process. The process of initially interconnecting the individual tiles 13 into the larger molded arrays 23 prior to application to the stack 9 of ballistic-resistant laminate sheets 3 may improve ease of manufacturing by improving ease of handling. The prior interconnecting process may also be used to constrain the tiles 13 in a manner that helps to resist shattering or at least fragmentation of the ceramic material when struck with an incoming armor piercing rifle round or fragmentation projectile.

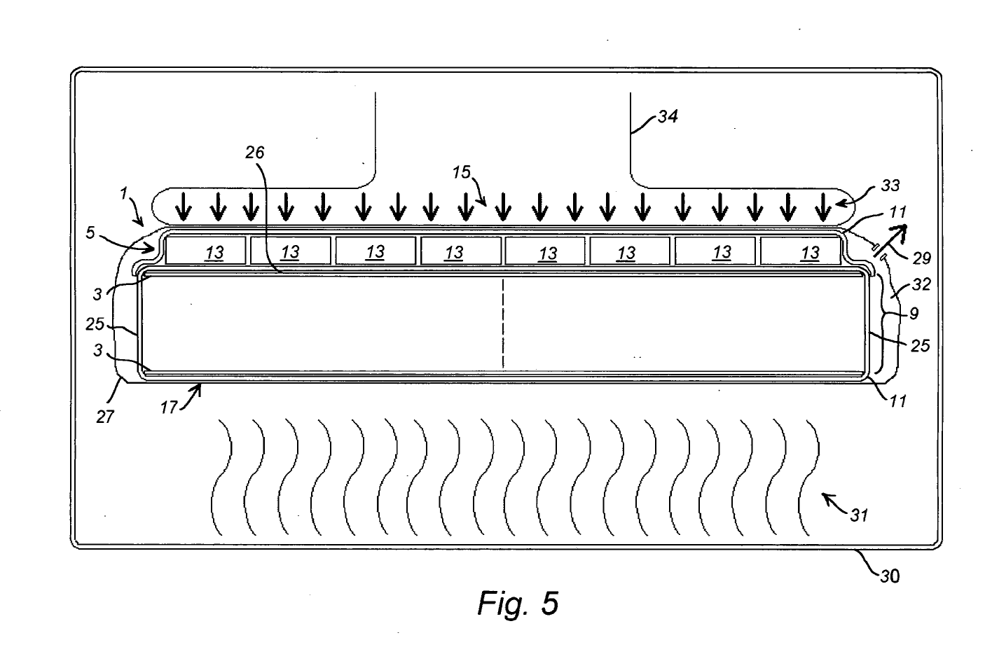

As illustrated in FIG. 5, manufacturing of the panel 1 occurs on a large plate, up to 4 feet wide and up to 8 feet long or larger. The ballistic-resistant laminate sheets 3 are laid out to form the stack 9, the resin-impregnated fiber encapsulation material 11 placed over the top or front 15 and sides 25 of the stack 9, as may be desired for either resistance to environmental exposure or additional processing such as painting. The ceramic tiles 13 of the fracturable layer 5 are laid out over the stack 9 of ballistic-resistant laminate sheets 3 on top of the layer of resin-impregnated fiber material 11, and another layer of resin-impregnated fiber material 11 is added.

Alternatively, ceramic tiles 13 of the fracturable layer 5 are arrayed directly on the common outer surface 26 of the topmost ballistic-resistant laminate sheet 3 of the stack 9, without the layer of resin-impregnated fiber material 11 in between. The resin-impregnated fiber encapsulation material 11 is then placed over the top or front 15 and sides 25 of both the fracturable layer 5 and the stack 9, as may be desired.

Relevant features of panel assembly 1 are effectively sealed in a sealable enclosure 27. For example, a sealable enclosure 27, such as a reusable collapsible silicone vacuum bag, encloses the entire panel assembly 1. A vacuum (indicated at 29) of about one atmosphere or in the range of about 27 to 29 inches of mercury, is drawn on the sealable enclosure 27 using a vacuum pump, then the assembly is set immediately into an oven 30 that is programmed with a ramped heating (indicated at 31), and optionally cooling, thermal cycle. Additionally, drawing the vacuum 29 on the collapsible vacuum bag 27 in ambient atmospheric conditions further operates for generating a differential pressure (indicated at 33) between an interior 32 of the collapsible vacuum bag 27 and ambient atmosphere which results in compressing the stack 9 of ballistic-resistant laminate sheets 3 and the ceramic tiles 13 of the fracturable layer 5 relative thereto. Therefore, drawing the vacuum 29 on the sealable and collapsible enclosure 27 substantially simultaneously further includes the act of compressing the stack 9 of ballistic-resistant laminate sheets 3 and substantially simultaneously therewith compressing the ceramic tiles 13 of the fracturable layer 5 relative to the ballistic-resistant laminate sheets 3 of the fragment containment layer 9.

Alternatively, the oven 30 is a vacuum oven, and the vacuum 29 and heating 31 are provided together in the vacuum oven 30. The pressure (indicated at 33) is alternatively applied mechanically to the fracturable and fragment containment layers 5 and 9, as by hydraulic or pneumatic press 34, during heating 31 for compressing the stack 9 of ballistic-resistant laminate sheets 3 and the ceramic tiles 13 of the fracturable layer 5 relative thereto. When cooled, the resultant fragment containment layer 9 portion of the panel 1 is drillable for fasteners. Such drilling, if desired, is optionally accomplished either by the manufacturer or by the end user, for example, in the field.

As discussed above, the resin portion of the encapsulation material 11 may be selected to have nearly the same melting or curing temperature as the melting point temperature of the polyethylene or other thermoplastic film of the ballistic-resistant laminate sheets 3. Accordingly, the encapsulation material 11 is melted or cured in the same operation and at the same time as melting of the thermoplastic film of the ballistic-resistant laminate sheets 3, which reduces process time. However, the encapsulation material 11 is optionally dissimilar from the thermoplastic film, and the resin portion may have a melting or curing temperature different from the thermoplastic film. Then the stack 9 of ballistic-resistant laminate sheets 3 and the resin-impregnated fiber encapsulation material 11 are processed in a single two-stage thermal cycle. In the single two-stage thermal cycle the stack 9 of ballistic-resistant laminate sheets 3, the resin-impregnated fiber material 11 and the ceramic tiles 13 of the fracturable layer 5 are all simultaneously heated in one heating stage to or above the melting point temperature of the thermoplastic film portion of the ballistic-resistant laminate sheets 3, and in another heating stage to or above either the melting point or curing point temperature of the resin portion of the encapsulation material 11. The two heating stages of the single two-stage thermal cycle are optionally ordered such that the stack 9 of ballistic-resistant laminate sheets 3, the resin-impregnated fiber encapsulation material 11 and the ceramic tiles 13 of the fracturable layer 5 are initially heated to at least the melting point temperature of the thermoplastic film portion of the ballistic-resistant laminate sheets 3 either before or after being heated to at least the melting point or curing point temperature of the resin portion of the encapsulation material 11.

Complete encapsulation of both the laminated stack 9 of processed ballistic-resistant laminate sheets 3 and the fracturable layer 5 of ceramic tiles 13 results in the panel end product 1 being both water resistant and UV resistant. However, as discussed herein, the encapsulation layer 11 is optionally trimmed, e.g. by saw, laser or water jet cutting, in a post-consolidation process that shapes the panel 1 with precision dimensions.

FIGS. 6 and 7 illustrate other embodiments of the panel 1 each having a substantially rigid support backing 35 between the ceramic tiles 13 of the fracturable layer 5 and the stack 9 of ballistic-resistant laminate sheets 3. By example and without limitation, the support backing 35 is a carbon fiber sheet material, such as a woven carbon fiber fabric. The support backing 35 is substantially rigid or stiff such that it provides a support backing surface for the ceramic tiles 13 during assembly and for seating against during thermal cycling in the vacuum 29 or under pressure 33.

In FIG. 6 the support backing 35 is positioned between the resin-impregnated fiber material 11 of the encapsulated stack 9 of ballistic-resistant laminate sheets 3 and the fracturable layer 5 of ceramic tiles 13, and is encapsulated with the resin-impregnated fiber material 11 encapsulating the ceramic tiles.

In FIG. 7 the support backing 35 is introduced directly onto the stack 9 of ballistic-resistant laminate structure sheets 3. Then, the resin-impregnated fiber material 11 is used to substantially encapsulate the ceramic tile 13 of the fracturable layer 5 along with both the support backing 35 and the stack 9 of processed ballistic-resistant laminate sheets 3.

Additionally, when the support backing 35 is a carbon fiber sheet material and the fiber portion of the encapsulation material 11 is fiberglass, the support backing 35 is lighter weight than the resin-impregnated fiberglass encapsulation material 11 so that either or both of thicker ceramic tiles 13 or more ballistic-resistant laminate structure sheets 3 may be included without an increase in weight of the resultant panel 1.

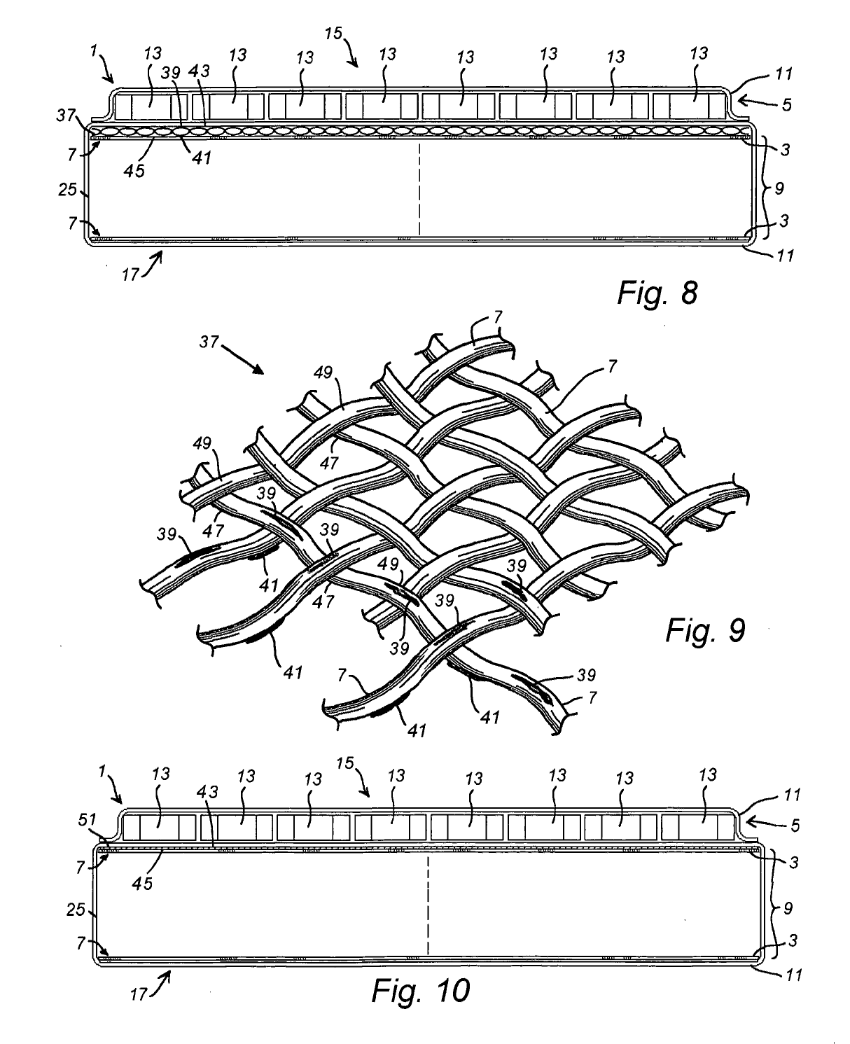

FIG. 8 illustrates an interface layer 37 of aramid or other high performance fibers optionally inserted between the top sheet 3 of ballistic-resistant laminate, i.e. nearest to the front strike face 15, and the resin-impregnated fiber encapsulation material 11. This interface layer 37 is particularly useful when the resin portion of the encapsulation material 11 is dissimilar from the polyethylene or other thermoplastic film of the ballistic-resistant laminate structure sheets 3 and has a different melt or cure rate, or if the resin portion is of a type that does not otherwise effectively bond or adhere directly to the polyethylene or other thermoplastic film. As illustrated in FIG. 9, the interface layer 37 is formed of high performance fiber materials 7 combined in a substantially continuous woven, knitted, braided or other undulating intertwined architecture. During thermal cycling of the panel 1 portions 43 of the melting or curing resin portion of the resin-impregnated fiber encapsulation material 11 bonds to forward portions 39 of the undulating intertwined architecture of fiber stands 7 nearest to the front face 15, and the thermoplastic film 45 of the top sheet 3 of ballistic-resistant laminate melts and bonds to after portions 41 of the fiber strands 7 nearest to the laminate stack 9. A thicker film of the polyethylene or other thermoplastic material facilitates joining the top sheet 3 of ballistic-resistant laminate to the interface layer 37. For example, one or more additional films of polyethylene or other thermoplastic material is positioned between the top sheet 3 of ballistic-resistant laminate and the fiber strands 7 of the interface layer 37. When the interface layer 37 is of woven fiber strands 7, intervening portions 47, 49 of the undulating intertwined fiber strands 7 prevent the fiber strands 7 from separating, which in turn prevents the encapsulation material 11 from separating from the laminate stack 9.

Alternatively, the resin-impregnated fiber material 11 is sewn, stitched, stapled or otherwise mechanically coupled to one or more of the sheets 3 of ballistic-resistant laminate material before the one or more of the sheets 3 are positioned on top of the stack of sheets 3 forming the balance of the fragment containment layer 9.

FIG. 10 illustrates yet another alternative for joining the laminate stack 9 of ballistic-resistant laminate sheets 3 to the resin-impregnated fiber encapsulation material 11. Here, a substantially continuous coating or film of adhesive 51 is substituted for the substantially continuous interface layer 37 of high performance fibers 7. Accordingly, the adhesive interface layer 51 is applied between the top sheet 3 of ballistic-resistant laminate and the encapsulation material 11. The adhesive interface layer 51 bonds both to the portions 43 of the resin portion of the resin-impregnated fiber encapsulation material 11 and to the thermoplastic film 45 of the top sheet 3 of ballistic-resistant laminate. The adhesive 51 is optionally either a thermoplastic adhesive, i.e. melting type, or a thermoset adhesive, i.e. curing type. As illustrated here, the adhesive interface layer 51 is applied substantially continuously between the top sheet 3 of ballistic-resistant laminate and the encapsulation material 11. Furthermore, the adhesive interface layer 51 is substantially coextensive with both the top sheet 3 of ballistic-resistant laminate and the encapsulation material 11.

FIG. 11 illustrates the panel 1 being optionally formed with precision dimensions. For example, the stack 9 of ballistic-resistant laminate sheets 3 and the substantially coextensive ceramic tiles 13 of the fracturable layer 5 are initially precisely dimensioned before processing for forming the finished panel 1. The resin-impregnated fiber encapsulation material 11 is limited to substantially covering the fracturable layer 5, and is initially precisely dimensioned to be substantially coextensive with the ceramic tiles 13 of the fracturable layer 5. As such, the sides 25 of the fragment containment stack 9, the ceramic tiles 13 of the fracturable layer 5, and the fiber encapsulation material 11 are pre-formed with substantially precision dimensions as may be desirable for some applications. Therefore, post-consolidation machining is eliminated, except for example optional drilling for attachment fasteners and the like.

Alternatively, the encapsulation layer 11 and the sides 25 of the fragment containment layer 9 of the processed panel 1 are illustrated as being optionally trimmed, e.g. by saw, laser or water jet cutting, in a post-consolidation process that shapes the panel 1 with precision dimensions. Accordingly, the sides 25 of the consolidated stack 9 of ballistic-resistant laminate sheets 3 are precisely dimensioned as may be desirable for some applications, yet the encapsulation layer 11 is also limited to only covering the fracturable layer 5 so that the sides 25 are exposed to the ambient environment.

The laminated armor panels 1 are optionally initially formed as large regular-shaped panels. Subsequently, the large regular-shaped panels are divided into smaller regular or irregular shaped panels, as may be desirable for some applications. For example, a cutting operation, such as jig saw, laser or water jet cutting, is performed on the large panel 1 in a post-consolidation process that traces between the ceramic tiles 13 of the fragmentation layer 5 for cutting only the fiber encapsulation layer 11 and consolidated stack 9 of ballistic-resistant laminate sheets 3 into the desired shapes. For example, a large rectangular panel 1 is optionally initially formed, then cuts are made in the fiber encapsulation layer 11 and stack 9 of ballistic-resistant laminate sheets 3 through the interstices between adjacent ceramic tiles 13. The may be utilized to divided the large rectangular panel 1 into many smaller rectangular pieces sized to fit into the pockets of a body armor vest, as discussed herein. This processing format of initially forming a large panel 1 and subsequently dividing it into multiple smaller panels may be more efficient, and therefore more cost effective, than forming the smaller panels directly.

Additionally, the initial large regular-shaped panel may be divided in a post-consolidation cutting process into special shapes, for example in the spirit of a dress pattern. Such post-consolidation cutting may be useful for forming special shapes, such as triangle, trapezoid, cross, “L,” “U” or “H” silhouette shapes, that may be desirable for achieving the most effective coverage of the target being protected. Optionally, the ceramic tile 13 are provided having the desired special shapes and are arranged on the stack 9 of ballistic-resistant laminate sheets 3 to achieve the desired panels 1 in the most cost effective manner.

Furthermore, the final fiber encapsulation layer 11 and consolidated stack 9 of ballistic-resistant laminate sheets 3 is machinable in small portions of the processed panel 1 devoid of ceramic tiles 13. For example, the processed panel 1 is machinable by initially omitting ceramic tiles 13 in strategic locations during manufacturing, and subsequently drilling the fiber encapsulation layer 11 and consolidated stack 9 of ballistic-resistant laminate sheets 3 for attachment fasteners in a post-consolidation process.

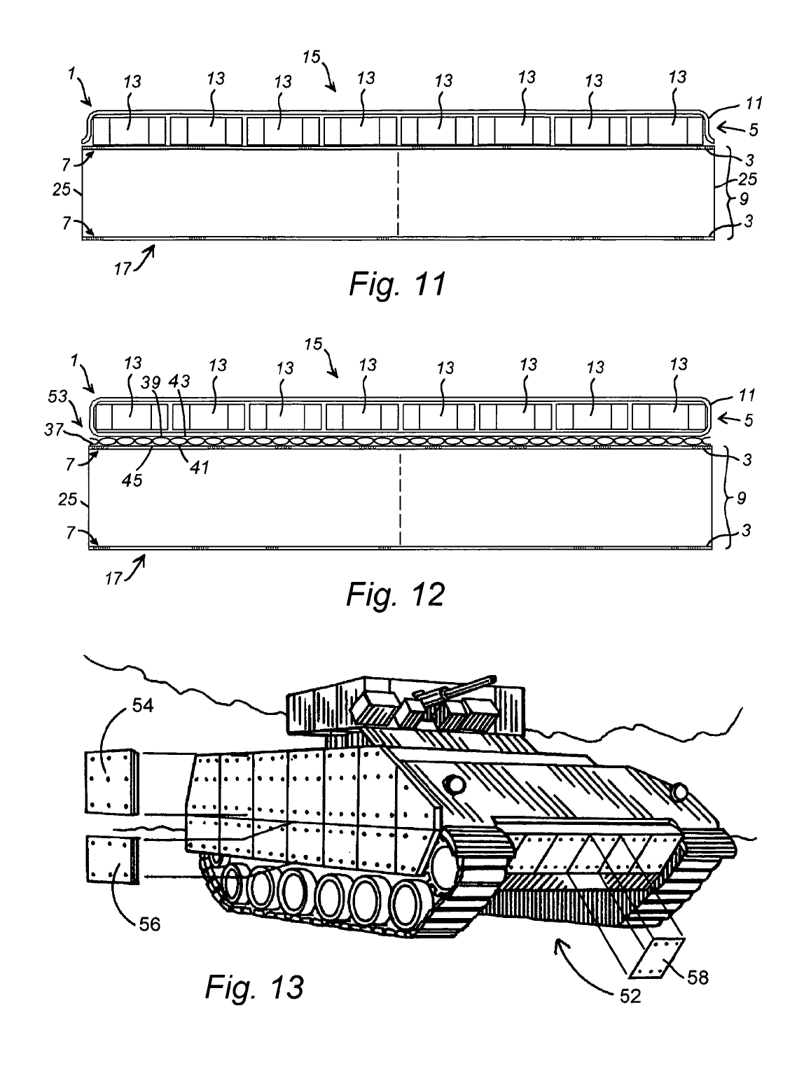

FIG. 12 illustrates another embodiment of the novel moldable ballistic armor panel 1 wherein the encapsulation layer 11 is formed substantially completely around the fracturable layer 5. Furthermore, the encapsulation is optionally eliminated from covering the fragment containment layer 9, except the encapsulation layer 11 covers the fragment containment layer 9 at an interface 53 between the fracturable and fragment containment layers 5 and 9. Optionally, the interface layer 37 of aramid or other high performance fibers is inserted between the top sheet 3 of ballistic-resistant laminate, i.e. nearest to the front strike face 15, and the nearest portion of resin-impregnated fiber encapsulation material 11 opposite from the strike face 15. As discussed herein, the interface layer 37 is particularly useful when the resin portion of the encapsulation material 11 is dissimilar from the polyethylene or other thermoplastic film of the ballistic-resistant laminate structure sheets 3 and is of a type that does not effectively bond or adhere directly to the polyethylene or other thermoplastic film.

Alternatively, the adhesive interface layer 51 is substituted for the interface layer 37 of aramid or other high performance fibers at the interface 53 for joining the encapsulated fracturable layer 5 to the fragment containment layer 9 when the resin portion of the encapsulation material 11 is dissimilar from the polyethylene or other thermoplastic film of the ballistic-resistant laminate structure sheets 3 and is of a type that does not effectively bond or adhere directly to the polyethylene or other thermoplastic film. Accordingly, the adhesive interface layer 51 is applied substantially continuously between the top sheet 3 of ballistic-resistant laminate of the fragment containment stack 9 and the resin-impregnated encapsulation material 11 that is substantially completely encapsulated around the tiles 13 of the fracturable layer 5. Furthermore, the adhesive interface layer 51 is substantially coextensive with both the top sheet 3 of ballistic-resistant laminate and the resin-impregnated encapsulation material 11 around the fracturable layer 5.

Applications

FIG. 13 is a three-dimensional exploded view that illustrates one application of the novel moldable ballistic armor panel 1 formed of the ballistic-resistant laminate structure 3 in combination with the fracturable layer 5 for defending against an incoming armor piercing rifle round or fragmentation projectile. Here, a plurality of the moldable ballistic armor panels 1 is installed on a tank body 52.

The manner in which plurality of the molded ballistic armor panels 1 may be used to protect a structure such as a tank or other military vehicle body 52, is shown only by example and without limitation and is not intended to limit such manner of installation. As illustrated here, side armor plate 54, skirt armor plate 56 and bow armor plate 58 each formed continuously of the moldable ballistic armor panel 1 provide exterior protection on a Bradley vehicle or other vehicle body 52, wherein the underlying structure provides full support for the armor plates 54, 56, 58. Thus, each of the continuous armor plates 54, 56, 58 includes the consolidated stack 9 of ballistic-resistant laminate structures 3 molded in combination with fracturable layer 5 for defending against an incoming armor piercing rifle round or fragmentation projectile. There are many potential applications for these two types of armor systems, including door armors for 5 ton trucks, PLS door armors, armors for the protected troop transporters, compartment armors and turret armors on HMMWV.

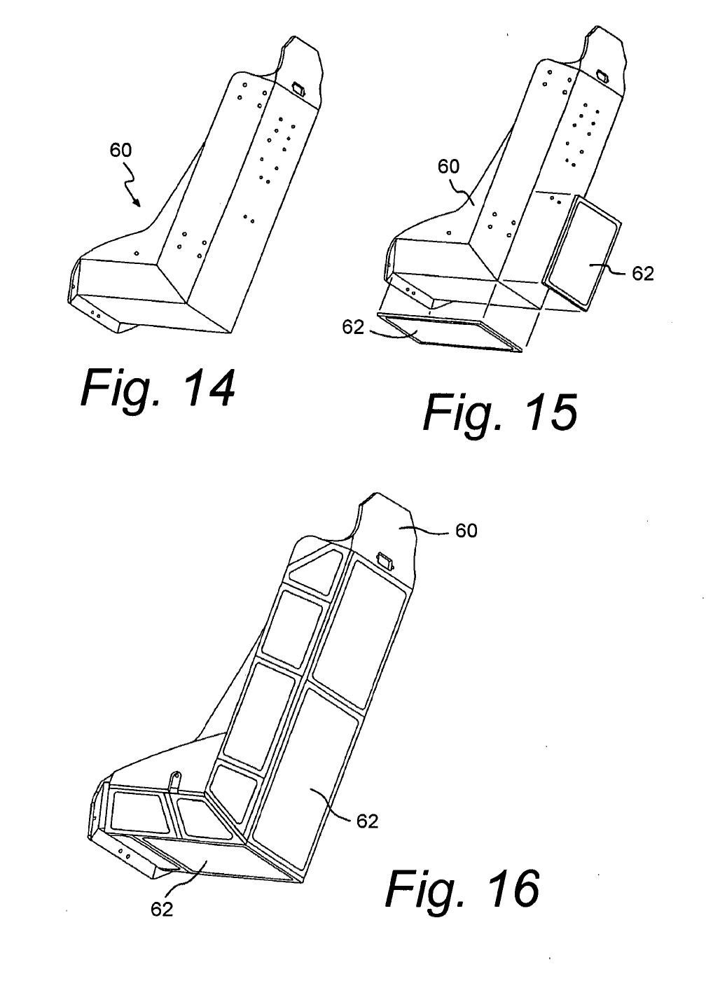

FIGS. 14, 15 and 16 illustrate another application of the novel moldable ballistic armor panel 1, wherein a plurality of the moldable ballistic armor panels 1 are installed on a vehicle seat 60. In FIG. 14, a plurality of the moldable ballistic armor panels 1 are bonded or otherwise attached to a composite laminate seat 60. For some applications, such as armored helicopter aircrew seats, large areas on the back, bottom and sides of the “bucket” of the seat 60 are provided with ballistic protection.

As shown in FIGS. 14, 15 and 16, ballistic protection is achieved, by example and without limitation using current manufacturing technology, by bonding, fastening or otherwise attaching a plurality of the precision fitted flat armor plates 62 in a “mosaic” pattern, to different exterior surfaces of composite bucket 60.

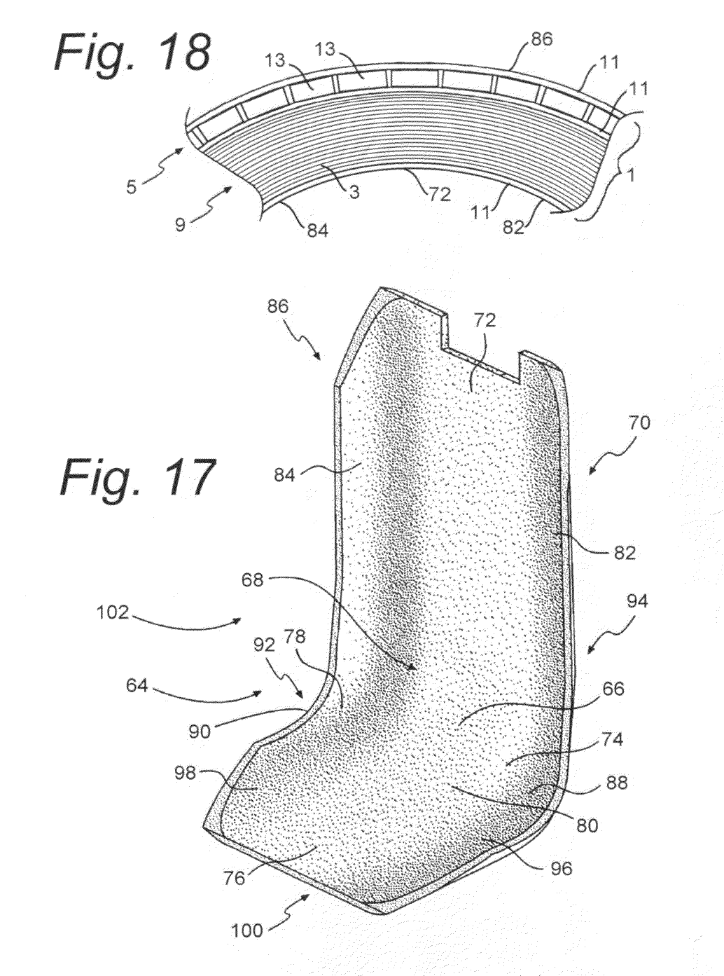

FIG. 17 shows a perspective view of an exemplary molded armor shell 64 of the moldable ballistic armor panel 1 for a vehicle seat. The exemplary molded armor shell 64 includes forward interior surface 66, forward interior space 68, and rearward exterior strike face 70. Conceptually, forward interior space 68 eventually accommodates an occupant of a seat with which molded armor shell 64 is configured to associate.

Molded armor shell 64 includes upper portion 72, curved portion 74 and seat portion 76. Upper portion 72 is connected to curved portion 74 at upper end 78 of curved portion 74. Likewise, seat portion 76 is connected to curved portion 74 at lower end 80 of curved portion 74.

Upper portion 72 includes first side portion 82 and second side portion 84. First side portion 82 of upper portion 72 extends forward, in the general direction of forward interior space 68 and includes at least one curved surface. Second side portion 84 of upper portion 72 also extends forward and includes at least one curved surface.

In one embodiment, first side portion 82 of upper portion 72, upper portion 72, and second side portion 84 of upper portion 72 are combined as a contoured continuous ballistic armor shell panel 86 molded of the moldable ballistic armor panel 1. Accordingly, as illustrated in FIG. 18 the moldable ballistic armor panel 1 forming the contoured ballistic armor shell panel 86 is molded continuously and includes the upper portion 72 with both the first and second side portions 82 and 84. The continuous ballistic armor shell panel 86 of the upper portion 72 is formed of a consolidated stack 9 of ballistic-resistant laminate structure sheets 3 molded in combination with fracturable layer 5 for defending against an incoming armor piercing rifle round or fragmentation projectile. The processed ballistic-resistant laminate sheets 3 in the continuous fragment containment layer 9 are formed of a continuous plurality of positionally stabilized unidirectional high performance fiber materials 7, and the fracturable layer 5 is formed of a continuous plurality of closely spaced ceramic tiles 13. Resin-impregnated fiber material 11 is used to at least partially or optionally substantially completely (shown) encapsulate the processed ballistic-resistant laminate sheets 3 in the laminated stack 9, as well as the ceramic tiles 13 of the fracturable layer 5, as discussed herein.

Curved portion 74 includes first side portion 88 and second side portion 90. As illustrated, first side portion 88 of curved portion 74 optionally extends forward and includes at least one curved surface. Second side portion 90 of curved portion 74 also optionally extends forward and includes at least one curved surface.

In one embodiment, first side portion 88 of curved portion 74, curved portion 74, and second side portion 90 of curved portion 74 are combined as a contoured continuous ballistic armor shell panel 92 molded of the moldable ballistic armor panel 1, similarly to the contoured continuous ballistic armor shell panel 86 forming the upper portion 72 with both the first and second side portions 82 and 84, as discussed herein.

In some embodiments, upper portion 72 and curved portion 74 are combined as a contoured continuous ballistic armor shell panel 94 molded of the moldable ballistic armor panel 1.

In some embodiments, upper portion 72 and curved portion 74 share at least one continuous surface.

Turning to seat portion 76, first side portion 96 of seat portion 76 extends forward and includes at least one curved surface. Second side portion 98 of seat portion 76 also extends forward and includes at least one curved surface.

In some embodiments, first side portion 96 of seat portion 76, seat portion 76, and second side portion 98 of seat portion 76 are combined as a contoured continuous ballistic armor shell panel 100 molded of the moldable ballistic armor panel 1, similarly to the contoured continuous ballistic armor shell panel 86 forming the upper portion 72 with both the first and second side portions 82 and 84, as discussed herein, and the contoured continuous ballistic armor panel 92 forming the curved portion 74 with both the first and second side portions 88 and 90, as also discussed herein.

In some embodiments in which there is no curved portion 74, upper portion 72 and seat portion 76 are molded of a monolithic piece of ceramic material.

In some embodiments, seat portion 76 and curved portion 74 are combined as a contoured continuous ballistic armor shell panel 102 molded of the moldable ballistic armor panel 1.

In some embodiments, seat portion 76, curved portion 74, and upper portion 72 are all molded of a monolithic piece of moldable ballistic armor panel 1.

In some embodiments, seat portion 76 and curved portion 74 share at least one continuous surface.

In some applications where producing the required area of armor coverage with a single-piece armor shell 64 as the contoured continuous ballistic armor shell panel 102 molded of the moldable ballistic armor panel 1 is impracticable, such as those involving very large structures or exceptionally complex surface shapes, the monolithic approach may be adapted such that a strategically minimal number of smaller partial shell panels 86, 92 and 100 may be employed.

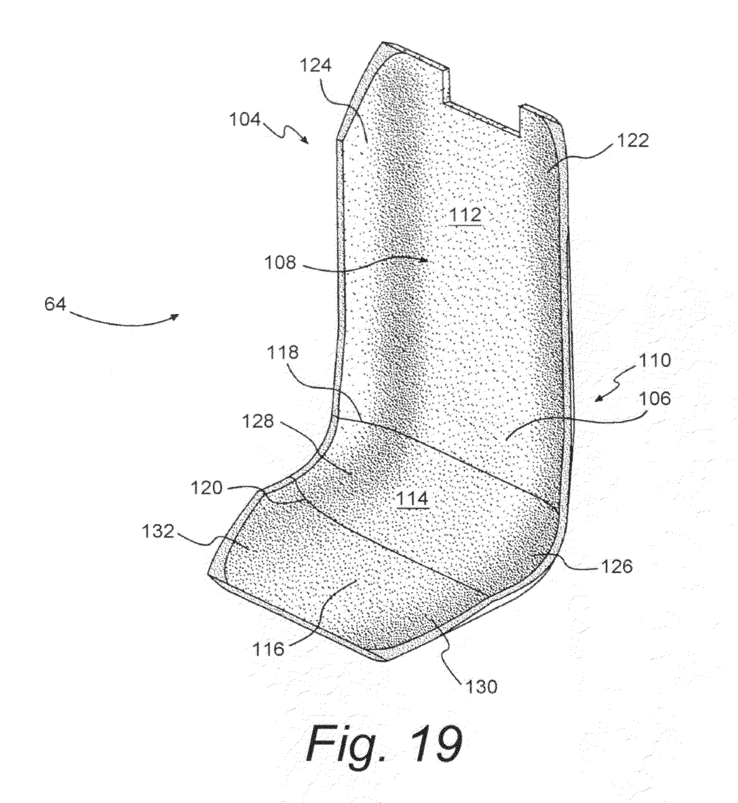

FIG. 19 is an isometric diagram that illustrates another embodiment of the molded armor shell 64 for a vehicle seat. This embodiment of molded armor shell 64 is an assembly of the smaller partial shell panels or members 86, 92 and 100 combined as a contoured ballistic armor shell assembly 104 instead of one monolithic contoured continuous ballistic armor shell panel 102.

Molded armor shell assembly 104 includes forward interior surface 106, forward interior space 108 and rearward exterior strike face 110. By example and without limitation, molded armor shell assembly 104 includes three separate members: upper member 112, curved member 114, and seat member 116. Although this embodiment uses three members, more or less members can be used. Upper member 112 is connected to curved member 114 at upper end 522 of curved member 114. Likewise, seat member 116 is connected to curved member 114 at lower end 120 of curved member 114.

Upper member 112 includes first side portion 122 and second side portion 124. First side portion 122 of upper member 112 extends forward, in the general direction of forward interior space 108 and includes at least one curved surface. Second side portion 124 of upper member 112 also extends forward and includes at least one curved surface.

In one embodiment, first side portion 122 of upper member 112, upper member 112, and second side portion 124 of upper member 112 are combined as a contoured continuous ballistic armor shell panel molded of the moldable ballistic armor panel 1.

Curved member 114 includes first side portion 126 and second side portion 128. First side portion 126 of curved member 114 optionally extends forward and includes at least one curved surface. Second side portion 128 of curved member 114 also optionally extends forward and includes at least one curved surface.

In one embodiment, first side portion 126 of curved member 114, curved member 114, and second side portion 128 of curved member 114 are combined as a contoured continuous ballistic armor shell panel molded of the moldable ballistic armor panel 1.

In some embodiments, seat member 116 includes first side portion 130 and second side portion 132. First side portion 130 of seat member 116 extends forward, in the general direction of forward interior space 108 and includes at least one curved surface. Second side portion 132 of seat member 116 also extends forward and includes at least one curved surface.

In one embodiment, first side portion 130 of seat member 116, seat member 116, and second side portion 132 of seat member 116 are combined as a contoured continuous ballistic armor shell panel molded of the moldable ballistic armor panel 1.

When the molded armor shell 64 is constructed using more than one monolithic molded armor shell panel, the molded partial shell panels include provisions that permit the easy assembly and alignment of the different shell members.

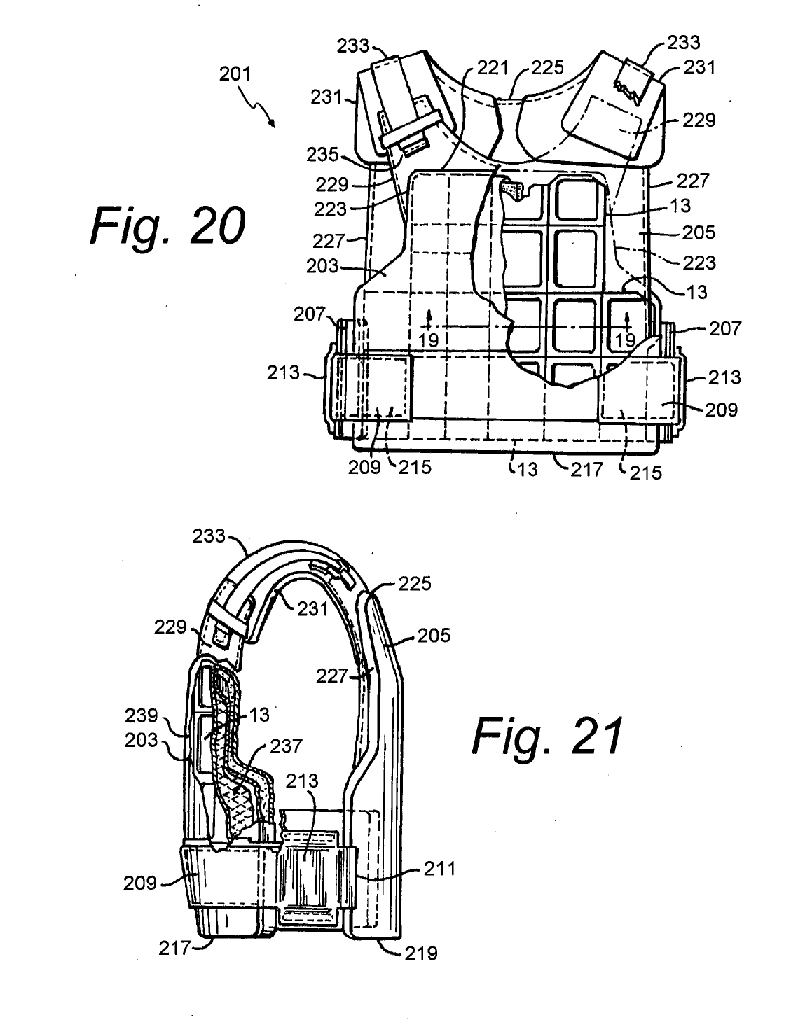

FIGS. 20 and 21 illustrate an articulated armor vest 201 of the novel moldable ballistic armor panel 1. The armor vest 201 includes a front armor panel 203, a rear armor panel 205, and two side panels 207. Straps 209 are anchored to the rear armor panel 205, as at 211, for extension through loops 213 on side panels 207. The forward ends of straps 209 have adhesive patches on their rear faces for engagement with adhesive patches 215 located on front armor panel 203, whereby the straps 209 serve to mount side panels 207 and to interconnect the front and rear panels 230, 205 near their respective lower edges 217, 219. Each adhesive patch may be formed of an adhesive fibrous hook and loop material, e.g., the materials marketed under the trademark VELCRO.

Front armor panel 203 has an upper edge 221, two side edges 223, and lower edge 217. The front armor panel 203 has sufficient area to protect the wearer's vital organs from frontal attack by a ballistic projectile. Rear armor panel 205 has an upper edge 225, two side edges 227, and lower edge 219. The rear armor panel 205 is optionally somewhat larger in area than the front armor panel 203, sufficient to protect the wearer's vital organs from ballistic attack from the zone behind the person wearing the vest 201. The front and rear armor panels 203, 205 are molded as contoured continuous ballistic armor panels of the moldable ballistic armor panel 1. The continuous ballistic front and rear armor panels 203, 205 are formed of a consolidated stack 9 of ballistic-resistant laminate structure sheets 3 molded in combination with fracturable layer 5 for defending against an incoming armor piercing rifle round or fragmentation projectile. The processed ballistic-resistant laminate sheets 3 in the continuous fragment containment layer 9 are formed of a continuous plurality of positionally stabilized unidirectional high performance fiber materials 7, and the fracturable layer 5 is formed of a continuous plurality of closely spaced ceramic tiles 13. resin-impregnated fiber material 11 is used to at least partially or optionally substantially completely (shown) encapsulate the processed ballistic-resistant laminate sheets 3 in the laminated stack 9, as well as the ceramic tiles 13 of the fracturable layer 5, as discussed herein.

The ceramic tiles 13 of the fracturable layer 5 cover essentially the entire areas of the respective front and rear armor panels 203, 205 for intercepting and defeating high velocity rifle projectiles directed at the wearer, e.g., a 30 caliber armor piercing projectile. Optionally, each side panel 207 is also formed of a consolidated stack 9 of ballistic-resistant laminate structure sheets 3 molded in combination with fracturable layer 5 for defending against an incoming armor piercing rifle round or fragmentation projectile side attack against the wearer's rib areas.

The upper portion of front armor panel 203 is designed to overlie the wearer's chest area just below shoulder level. Optionally, a flexible scalloped panel 229 formed of a stack 9 of ballistic-resistant laminate structure sheets 3 is sewn or otherwise attached to the upper portion of front armor panel 203 to extend up to the wearer's shoulders. Two shoulder pads 231 extend from rear armor panel 205 over the wearer's shoulders and overlap the scalloped panel 229. Flexible straps 233 extend from the shoulder pads 231 for releasable attachment to panel 229, as by means of VELCRO fasteners, as indicated in FIG. 1. A VELCRO patch 235 is attached to each panel 229 to cooperate with patches of mating VELCRO fasteners secured on the under side of each of straps 233. The VELCRO adhesive patches 235 are fibrous hook and loop material, as earlier indicated. The effective length of each strap 233 is adjustable by means of the buckle arrangement indicated, to meet individual size requirements, with the end portions of straps 233 being retained by loops secured to panels 229, as shown.

The present invention involves the internal construction of front armor panel 203 and/or rear armor panel 205, whereby a wearer is effectively protected from projectile attack. Each armor panel 203 or 205 may have similar internal construction, although the number of ceramic tiles 13 employed in the rear panel will be greater because of its greater face area.

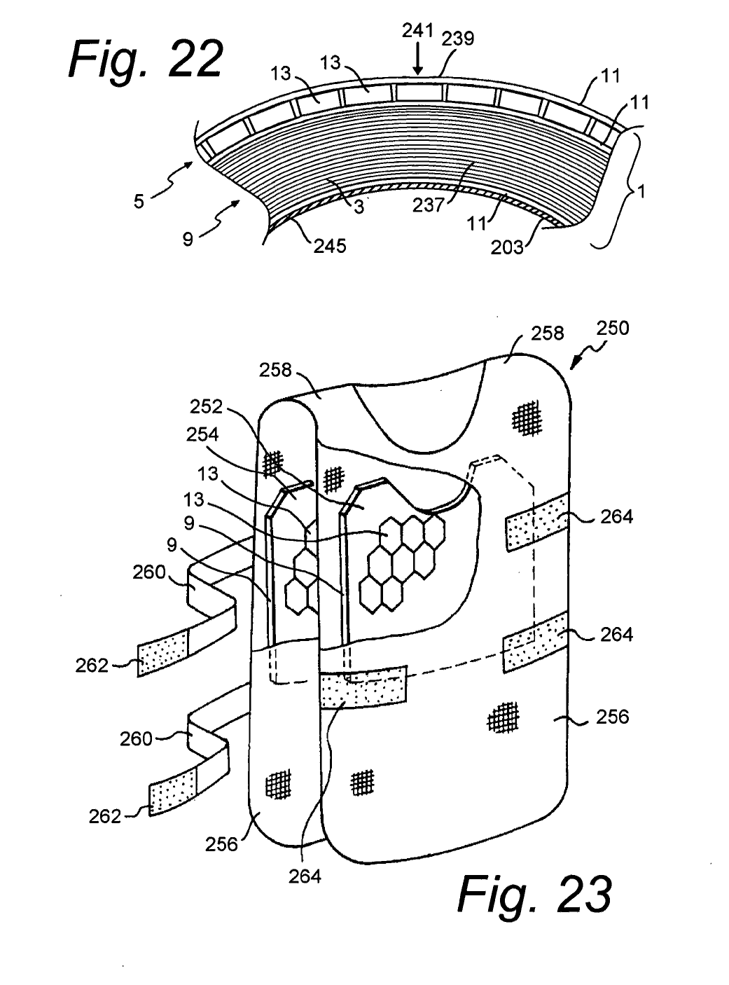

FIG. 22 illustrates in some detail a representative construction of either or both of the front armor panel 203 and rear armor panel 205 of armor vest 201. The flexible panel 229 includes a fragment trapping blanket 237 formed of the fragment containment layer 9 of consolidated ballistic-resistant laminate structure sheets 3, whereby the blanket captures and retains fragments and particulates generated by projectile impact against ceramic tiles 13 that are molded to the outer surface of the blanket 237 on strike face 239 of the front armor panel 203. A projectile path against the armor panel is indicated by arrow 241.

Either or both of the front armor panel 203 and rear armor panel 205 of armor vest 201 optionally includes a second relatively soft foam layer 245 is secured to the inner surface of blanket 237. This plastic foam material is optionally that marketed under the trade name ENSOLITE. The optional foam layer 245 may be about one quarter to one-half inch in thickness. The purpose of optional foam layer 245 is to space blanket 237 from the wearer's body, and thus to accept blanket deformation, when a projectile fragments tiles 13 to deform the blanket 237, and thereby shield the wearer from such deformation.

FIG. 23 illustrates another example of an armor vest 250 formed of the novel moldable ballistic armor panel 1. The armor vest 250 includes a front armor panel 252, and optionally includes a rear armor panel 254, each covered in a suitable knitted or woven cloth 256 having a good permeability, and mutually suspended by shoulder straps 258. The front armor panel 252 and optional rear armor panel 254 are optionally either flat or contoured, and are molded as contoured continuous ballistic armor panels of the moldable ballistic armor panel 1. The continuous ballistic armor shell panel front and rear armor panels 252, 254 are formed of a consolidated stack 9 of ballistic-resistant laminate structure sheets 3 molded in combination with fracturable layer 5 for defending against an incoming armor piercing rifle round or fragmentation projectile. The processed ballistic-resistant laminate sheets 3 in the continuous fragment containment layer 9 are formed of a continuous plurality of positionally stabilized unidirectional high performance fiber materials 7, and the fracturable layer 5 is formed of a continuous plurality of closely spaced ceramic tiles 13. Resin-impregnated fiber material 11 is used to at least partially or optionally substantially completely (shown) encapsulate the processed ballistic-resistant laminate sheets 3 in the fragment containment layer 9, as well as the ceramic tiles 13 of the fracturable layer 5, as discussed herein.

The front armor panel 252 and optional rear armor panel 254 are a suitable size of sufficient area to protect the wearer's vital organs from frontal attack by a ballistic projectile. The front armor panel 252 is arranged on a breast portion of the armor vest 250, and two tapes or belts 260 each having at an end portion thereof a coupler 262, such as an adhesive fibrous hook and loop material, e.g., the materials marketed under the trademark VELCRO. The two tapes or belts 260 are attached to a right side and a left side of cloth 256 covering rear armor panel 254 at a back portion of the armor vest 250, and corresponding couplers 264 are attached to a right side and a left side of cloth 256 covering front armor panel 252 at a front portion of the armor vest 250. The armor vest 250 can be fitted to a human body by pressing and fixing the couplers 262 on the belts 260 to the corresponding couplers 264, respectively.

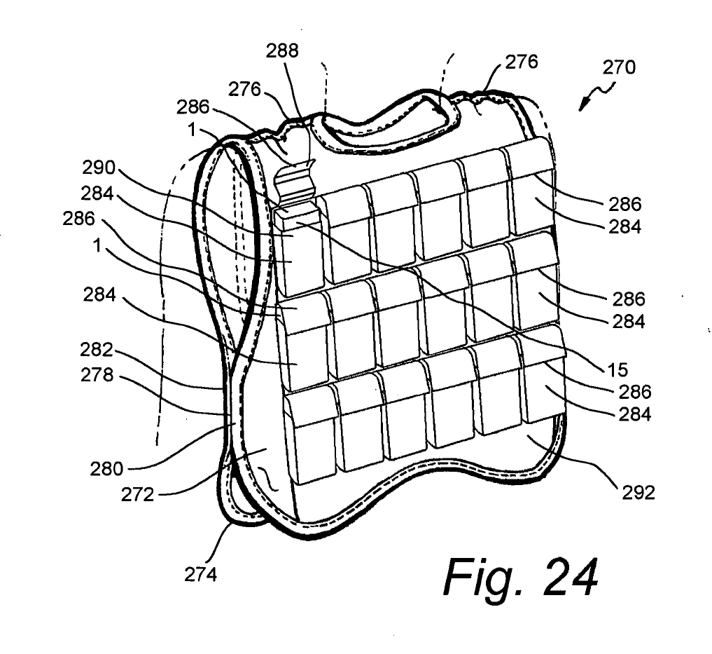

FIG. 24 illustrates yet another example of an armor vest 270 formed of the novel moldable ballistic armor panel 1. The armor vest 270 includes a front vest panel 272 and a rear vest panel 274 interconnected and mutually suspended by shoulder straps 276 along their adjoining top portions. The front and rear vest panels 272, 274 are secured by appropriate closure means 278 along their corresponding side portions 280, 282 to secure the armor vest 270 on the wearer.

At least the front vest panel 272 of armor vest 270, and optionally the rear vest panel 274, is provided with a plurality of closely spaced pockets 284 each sized to receive a miniature one of the novel moldable ballistic armor panels 1 formed of the fragment containment layer 9 of consolidated ballistic-resistant laminate structure sheets 3 molded in combination with fracturable layer 5 of at least one, and optionally more, ceramic sheet or tile 13 on the front strike face 15 thereof for defending against an incoming armor piercing rifle round or fragmentation projectile attack. The miniature ballistic armor panels 1 are received in the pockets 284 with their respective strike faces 15 facing outwardly away from the vest 270 toward an incoming armor piercing rifle round or fragmentation projectile.

Means are provide for securing the miniature ballistic armor panels 1 in the pockets 284. For example, each pocket 284 has a covering flap 286 and means for securing it to the face of the corresponding over covering the pocket opening, as shown. The securing means is optionally provided as a coupler 288 positioned at an end portion thereof, such as an adhesive fibrous hook and loop material, e.g., the materials marketed under the trademark VELCRO, while each pocket 284 has corresponding coupler 290 attached to its front face in a position to receive the coupler 288.

The front and rear vest panels 272, 274 of armor vest 270 are formed of a suitable knitted or woven cloth having a good permeability. Furthermore, the front vest panel 272 of armor vest 270, and optionally the rear vest panel 274, includes a ballistic-resistant layer 292 behind the pockets 284 of miniature ballistic armor panels 1. For example, the ballistic-resistant layer 292 of front vest panel 272 of armor vest 270, and optionally of rear vest panel 274, is a ballistic-resistant blanket having a high resistance to penetration by incoming conventional ballistic projectiles, i.e. non-armor piercing rifle rounds. By example and without limitation, the ballistic-resistant layer 292 is formed of a plurality of the ballistic-resistant laminate structure sheets 3 each formed of a plurality of the positionally stabilized unidirectional high performance fiber materials 7. The ballistic-resistant layer 292 resists penetration of incoming conventional ballistic projectiles that miss the miniature ballistic armor panels 1. Furthermore, the ballistic-resistant layer 292 engages and traps fragments of the ceramic tile 13 fractured by the impact.

While the preferred and additional alternative embodiments of the invention have been illustrated and described, it will be appreciated that various changes can be made therein without departing from the spirit and scope of the invention.

What is claimed is:

1: A moldable ballistic armor panel, comprising:
a fracturable layer;
a fragment containment layer substantially coextensive with the fracturable layer and laminated thereto;
a resin-impregnated fiber material at least partially covering the fracturable layer; and
the fracturable layer, fragment containment layer and resin-impregnated fiber material being molded in a substantially unitary whole.

2: The armor panel of claim 1, further comprising a layer of resin-impregnated fiber material laminated between the fracturable and fragment containment layers.

3: The armor panel of claim 2, further comprising a substantially continuous interface layer laminated between the resin-impregnated fiber material and the fragment containment layer, the interface layer further comprising one of a layer of high performance fiber materials, and a layer of adhesive.

4: The armor panel of claim 1 wherein the fracturable layer further comprises a substantially continuous unitary sheet of fracturable material having an impact surface facing away from the fragment containment layer, and further comprising an array of fracture arresters formed at least across the impact surface thereof.

5: The armor panel of claim 1 wherein the fracturable layer further comprises an array of individual tiles of fracturable material.

6: The armor panel of claim 5, further comprising a substantially rigid support structure laminated between the fracturable layer and the fragment containment layer.

7: The armor panel of claim 6, further comprising a layer of resin-impregnated fiber material laminated between the support structure and the fragment containment layer.

8: The armor panel of claim 1 wherein the resin-impregnated fiber material further at least partially encapsulates both the laminated fracturable layer and fragment containment layer.

9: The armor panel of claim 8 wherein the laminated fracturable layer and fragment containment layer are both further substantially completely encapsulated by the layer of resin-impregnated fiber material.

10: A moldable ballistic armor panel, comprising:
a first outwardly-positioned fracturable layer comprising a ceramic material;
a second inwardly-positioned fragment containment layer comprising a substantially consolidated stack of ballistic-resistant laminate sheets, the fragment containment layer being substantially coextensive with the fracturable layer and coupled thereto;
a resin-impregnated fiber material comprising a high strength fiber material infused with a resin, the resin-impregnated fiber material at least substantially covering the fracturable layer; and
the fracturable layer, the fragment containment layer, and the resin-impregnated fiber material being consolidated in a substantially unitary whole.

11: The armor panel of claim 10 wherein the resin-impregnated fiber material further comprises an encapsulation layer at least partially encapsulating the laminated fracturable and fragment containment layers.

12: The armor panel of claim 10, further comprising a layer of the resin-impregnated fiber material laminated between the fracturable and fragment containment layers.

13: The armor panel of claim 12, further comprising a substantially continuous interface layer laminated between the resin-impregnated fiber material and the fragment containment layer, the interface layer comprising one of a substantially continuous undulating intertwined architecture of high performance fiber materials, and a substantially continuous layer of adhesive.

14: The armor panel of claim 10 wherein the fracturable layer further comprises a single substantially continuous unitary sheet of the ceramic material having an impact surface facing away from the fragment containment layer, and further comprising an array of fracture arresters formed at least across the impact surface thereof.

15: The armor panel of claim 10 wherein the fracturable layer further comprises a plurality of closely spaced individual unitary tiles of the ceramic material arrayed along a common surface.

16: The armor panel of claim 15, further comprising a substantially rigid support layer laminated between the fracturable layer and the fragment containment layer.

17: The armor panel of claim 16, further comprising a layer of the resin-impregnated fiber material laminated between the support layer and the fragment containment layer.

18: The armor panel of claim 15 wherein the common surface having the ceramic material arrayed there along, further comprises an at least partially contoured surface.

19: The armor panel of claim 10 wherein the one or more of the ballistic-resistant laminate sheets further comprises a plurality of positionally stabilized unidirectional high performance fiber materials, and further comprising:
no more than about 25% by weight of thermoplastic material,
no more than about 5% by weight of adhesive adhering the sheets of thermoplastic material to the high performance fiber materials, and
a balance of the high performance fiber materials.

20: A method for molding a ballistic armor panel, the method comprising:
stacking together a plurality of ballistic-resistant laminate sheets in a fragment containment layer comprising a common outer surface, each of the ballistic-resistant laminate sheets comprising a plurality of positionally stabilized unidirectional high performance fiber materials;
positioning a fracturable layer comprising a ceramic material substantially coextensive with the common outer surface of the fragment containment layer;
positioning a resin-impregnated fiber material comprising a high strength fiber material over at least the fracturable layer;
sealing the fragment containment layer, the fracturable layer and the resin-impregnated fiber material in a sealable enclosure;
with the fragment containment layer, the fracturable layer and the resin-impregnated fiber material enclosed in the sealable enclosure, drawing a vacuum on the sealable enclosure;
compressing the ceramic material of the fracturable layer relative to the ballistic-resistant laminate sheets of the fragment containment layer; and
while being enclosed in the sealable enclosure and the vacuum being drawn thereon, heating the fragment containment layer, the fracturable layer and the resin-impregnated fiber material.

21: The method of claim 20 wherein the sealing the fragment containment layer, the fracturable layer and the resin-impregnated fiber material in a sealable enclosure further comprises entirely enclosing the fragment containment layer, the fracturable layer and the resin-impregnated fiber material in a collapsible vacuum bag.

22: The method of claim 21 wherein the drawing a vacuum on the sealable enclosure further comprises the compressing the ceramic material of the fracturable layer relative to the ballistic-resistant laminate sheets of the fragment containment layer.

23: The method of claim 20 wherein the positioning a fracturable layer comprising a ceramic material substantially coextensive with the common outer surface of the fragment containment layer further comprises closely spacing a plurality of individual unitary tiles of the ceramic material in an array substantially coextensive with the common outer surface of the fragment containment layer.

24: The method of claim 23, further comprising positioning a substantially rigid support layer between the fragment containment layer and the fracturable layer.

25: The method of claim 23, further comprising positioning a resin-impregnated fiber material comprising a resin and an undulating intertwined architecture of high strength fiber material between the fragment containment layer and the fracturable layer.

26: The method of claim 25 wherein the positioning a resin-impregnated fiber material between the fragment containment layer and the fracturable layer further comprises:
selecting the resin-impregnated fiber material to be dissimilar from a thermoplastic film portion of the ballistic-resistant laminate sheets of the fragment containment layer;
selecting an interface layer comprising, one of: a layer of undulating intertwined architecture of high performance fiber materials, and a layer of adhesive; and
positioning the interface layer substantially continuously between the dissimilar resin-impregnated fiber material and the fragment containment layer.

27: The method of claim 20 wherein the positioning a resin-impregnated fiber material comprising a high strength fiber material over the fracturable layer and fragment containment layer further comprises:
selecting the resin-impregnated fiber material to further comprise a resin having one of a melting point temperature and curing point temperature commensurate with a melting point temperature of a thermoplastic film portion of the ballistic-resistant laminate sheets.

28: The method of claim 20, further comprising at least partially encapsulating the laminated fracturable and fragment containment layers with the resin-impregnated fiber material.

29: The method of claim 28, further comprising subsequently trimming at least a portion of the resin-impregnated fiber material from one or more edge portions of the fragment containment layer.

30: The method of claim 20 wherein the positioning a resin-impregnated fiber material comprising a high strength fiber material over the fracturable layer and fragment containment layer further comprises:
selecting the resin-impregnated fiber material further comprising a resin dissimilar from a thermoplastic film portion of the ballistic-resistant laminate sheets, and having one of a melting point temperature and curing point temperature different from a melting point temperature of a thermoplastic film portion of the ballistic-resistant laminate sheets; and
at least partially encapsulating the laminated fracturable and fragment containment layers with the resin-impregnated fiber material; and
wherein the heating the fragment containment layer, the fracturable layer and the resin-impregnated fiber material further comprises:
heating the fragment containment layer, the fracturable layer and the resin-impregnated fiber material to at least the melting point temperature of the thermoplastic film portion of the ballistic-resistant laminate sheets, and
either initially or subsequently to at least the heating the fragment containment layer, the fracturable layer and the resin-impregnated fiber material to the melting point temperature of the thermoplastic film portion of the ballistic-resistant laminate sheets, heating the fragment containment layer, the fracturable layer and the resin-impregnated fiber material to at least the one of a melting point temperature and curing point temperature of the dissimilar resin.

31: The method of claim 30 wherein the heating the fragment containment layer, the fracturable layer and the resin-impregnated fiber material further comprises a solitary two-stage thermal cycle, the solitary two-stage thermal cycle comprising:
the heating the fragment containment layer, the fracturable layer and the resin-impregnated fiber material to at least the melting point of the thermoplastic film portion of the ballistic-resistant laminate sheets, and
the heating the fragment containment layer, the fracturable layer and the resin-impregnated fiber material to at least the one of a melting temperature and curing temperature of the dissimilar resin.

32: The method of claim 20 wherein the stacking together a plurality of ballistic-resistant laminate sheets in a fragment containment layer comprising a common outer surface, each of the ballistic-resistant laminate sheets comprising a plurality of positionally stabilized unidirectional high performance fiber materials, further comprises stacking together a plurality of ballistic-resistant laminate sheets comprising: no more than about 25% by weight of thermoplastic material, no more than about 5% by weight of adhesive adhering the sheets of thermoplastic material to the high performance fiber materials, and a balance of the high performance fiber materials.
